(19) United States
(12) Patent Application Publication
(10) Pub. No.: US 2026/0309247 A1
(43) Pub. Date: Oct. 8, 2026

(54) A VALVE BLOCK FOR A SOLUTION MANAGEMENT SYSTEM FOR BIOPROCESSING

(71) Applicant: CYTIVA SWEDEN AB, Uppsala (SE)

(72) Inventors: Klas Marteleur, Uppsala (SE); Johan Alriksson, Uppsala (SE)

(21) Appl. No.: 19/474,785

(22) PCT Filed: Apr. 11, 2024
(86) PCT No.: PCT/EP2024/059824

§ 371 Date: Oct. 14, 2025

(30) Foreign Application Priority Data
Apr. 14, 2023 (GB) 2305519.7

(51) Int. Cl. F16K 27/00; F16K 27/02

(52) U.S. Cl. CPC F16K 27/003; F16K 27/0236

(57) ABSTRACT

The present disclosure relates to a valve block (100) for controlling a flow of fluid into, or out of, a solution management system (200) for bioprocessing, the valve block being a single unit and comprising: at least one inlet port (10); at least one outlet port (20); and four or more valve sections (30) fluidly connected to the at least one inlet port and the at least one outlet port, each valve section being configured to receive a valve element (32) for control of fluid through the valve block; wherein at least two valve sections are fluidly connected with each other by means of an integrally formed first channel (40), which changes direction two or more times.

### TECHNICAL FIELD

The present disclosure relates to a to a valve block for controlling a flow of fluid into, and/or out of, a solution management system for bioprocessing and a solution management system for bioprocessing comprising such a valve block. More specifically, the present disclosure relates to a valve block and a solution management system for bioprocessing comprising such a valve block as defined in the introductory parts of the independent claims.

### BACKGROUND ART

Valve blocks are used for various applications and are typically manufactured from a solid block. A valve block comprises one or more inlet ports, outlet ports and valves connected by means of drilled channels inside the valve block. The channels are straight but by drilling two channels perpendicularly to each other such that they intersect, a 90 degrees direction change can be obtained. Commonly known valve blocks are often combined or stacked on top of each other in order to achieve desired flow paths by means of connected channels. However, combining valve blocks require sealing arrangements between the valve blocks to prevent leakages.

In solution management systems for bioprocessing, valve blocks are used for solution inlets and/or solution outlets. Such systems may comprise multiple inlets and outlets for different solutions or fluids and multiple valve blocks are often combined. As previously mentioned, combining valve blocks requires sealing arrangements. Seals generally result in small crevices, which in worst case will act as dirt pockets resulting in cross contamination. This is a challenge with known valve blocks.

### SUMMARY

It is an object of the present invention to provide a valve block for a solution management system for bioprocessing, which solves or alleviates at least some of the challenges with traditional valve blocks used for solution and buffer management in the pharma and biotech industry.

According to a first aspect of the present disclosure, there is provided a valve block for controlling a flow of fluid into, and/or out of, a solution management system for bioprocessing in a sterile/aseptic environment, the valve block being a single unit and comprising: at least one inlet port; at least one outlet port; and four or more valve sections fluidly connected to the at least one inlet port and the at least one outlet port, each valve section being configured to receive a valve element for control of fluid through the valve block; wherein at least two valve sections are fluidly connected by means of an integrally formed first channel, which changes direction two or more times.

By means of the single unit valve block (monoblock) with four or more valve sections as disclosed herein, the integrally formed first channel being able to change direction two or more times will enable the fluid within a single valve block to be conveyed in a more flexible and complex way. For example, the first channel enables bypassing valve sections, channels, inlet ports or outlet ports in the same plane in the valve block. This way, valve sections, inlet ports and outlet ports in the valve block that are not arranged adjacent each other can be fluidly connected in a space-efficient way. Thus, instead of having to increase the thickness of the valve block and bypass components in a different plane, the first channel allows the valve block as disclosed herein to be made more compact with less material usage and thereby with reduced weight. This is advantageous from a sustainability perspective and will also facilitate mounting of the valve block in the solution management system as well as maintenance. The integrally formed first channel also increases the ability to provide customized flow paths inside the valve block, and thereby reduces the need of combining multiple valve blocks. This way, seals between different valve blocks and potential cross contamination can be avoided.

The valve sections in the valve block may be directly or indirectly fluidly connected to the at least one inlet port and the at least one outlet port. Thus, a valve section may be directly connected to the inlet port and/or outlet port or the valve section may be connected to the inlet port and/or outlet port via another valve section.

The first channel may have a substantially constant cross-sectional area. Thus, the cross-sectional area of the first channel may be essentially the same along the extension of the first channel even when changing direction. This way, reduced restrains on the flow in the first channel and lower backpressure may be achieved.

In one example, the at least two fluidly connected valve sections are diagonally arranged in the valve block. To fluidly connect two valve sections that are diagonally arranged can be difficult in conventional valve blocks since it requires several straight drilled channels to intersect. By having an integrally formed first channel that changes direction at least two times, diagonally arranged valve sections can be fluidly connected in a space-efficient way.

The four or more valve sections may all be fluidly connected with each other. The valve sections may be fluidly connected via a centrally arranged channel, fluidly connected to the at least one inlet port and/or the at least one outlet port. Alternatively, the four or more valve sections are fluidly connected with each other by means of different channels connecting them sequentially.

The valve block may be manufactured by means of additive manufacturing. Alternatively, the valve block may be manufactured by molding or casting. By using additive manufacturing, molding or casting, the valve block can be configured with desired flow paths in a space-efficient way. The valve block can thereby be more compact and require less material. Additive manufacturing or 3D printing may be performed in polypropylene (PP), polyetherketone (PEEK), stainless steel or other materials compatible with typical bioprocess process fluids and cleaning agents. As the valve block can be 3D printed or molded in different plastic materials, the CO2-footprint of the production of such a valve block is reduced as compared to valve blocks comprising metal. Further, as the valve block may be printed or molded in plastics, the valve block will weigh less. Also, by being able to form the channels more freely, the channels can be routed to have the at least one inlet port and/or the at least one outlet port at a position lower than the valve section. This way, drainability of the valve block can be improved.

Such 3D printed parts may also be printed and/or surface treated to enable optimised cleaning or minimised biological contaminant adherence to be obtained (e.g. by way of surface heat treatment, etc.—see WO2023/156477A1, PCT/EP24/050808, SE2350629-8 and/or WO2024/061643A1 which are hereby fully incorporated by reference).

In one example, the first channel is delimited by channel walls having a thickness between 1.6-5 millimetres. The thickness of the channel walls of the first channel may vary along the extension of the first channel. It is to be understood that the first channel and any other channel in the valve block as disclosed herein, can be referred to as a conduit, pipe or passage. All channels in the valve block may be delimited by channel walls having a thickness between 1.6-5 millimetres. The first channel being delimited by channel walls having a thickness between 1.6-5 millimetres differs the valve block from conventional solutions where the channels are drilled holes in a solid block. By forming walls with certain thickness instead of removing material (drilling) from a solid block, the valve block can be configured somewhat hollow. This way, less material is used and the weight of the valve block is reduced.

The channel walls delimiting the first channel may be continuous along the longitudinal extension of the first channel. By having a first channel with continuous walls without joints or seals, a better flow is achieved within the valve block, and the risk for leakage and contamination is reduced. Also, with continuous walls an improved flow of fluid inside the channel may be achieved.

In one example, the valve block further comprises a second channel, wherein the first channel and the second channel extend in different planes within the valve block and passes each other without intersecting. The first channel changing direction at least two times enables a more space-efficient routing of the channels in the valve block. The second channel may be configured similarly as the first channel and may thus change direction two or more times. Alternatively, the second channel is differently configured compared to the first channel. The valve block may comprise a plurality of channels and they may be similar to the first channel or not. Some channels may be straight, others may change direction one time only, and others may change direction three or more times.

The first channel may comprise at least two curved sections changing the direction of the first channel at least two times. The curved sections may be configured such that the first channel is essentially U-shaped or S-shaped. The curved sections may each be configured to provide an essentially 90-degree change of direction. In some examples, the curved sections are configured to provide a change of direction between 45-135 degrees. The curved sections may be configured to provide a change in direction in x, y or z-direction.

The first channel may comprise at least two curved sections changing the direction of the first channel at least two times, wherein at least one curved section is configured, such that the radius of the curvature varies along at least a part of the length of the curved section. The radius of the curvature of the at least one curved section may vary while maintaining a constant cross-sectional area of the first channel. This way, sharp bends or corners can be avoided and a continuous flow of fluid inside the channel can be achieved. In another example, at least one curved section of the first channel has an inner cross-sectional geometry varying along at least a part of the length of the curved section. Thus, the first channel may have a cross-sectional geometry varying along at least a part of the length of the first channel.

By having a curvature radius and/or cross-sectional geometry varying along at least a part of the length of the curved section, the problem with hold-up volumes in the channel may be reduced, steady state flow may be reached faster, there may be lower backpressure and less risk of stagnant zones in the channel. Also, a lower pressure drop before and after the curved section may be achieved and a smoother flow may be achieved, as compared to traditional valve blocks with drilled right-angled bends. The pressure drop before and after a substantially 90° curved section having a curvature radius and/or cross-sectional geometry varying along at least a part of the length of the curved section, as compared to a corresponding substantially 90° curved section with a constant inner cross-sectional geometry and/or curvature radius, can be reduced by at least 20% at a solution flow rate of 2000-2400 l/h through the channel.

The inner diameter of the first channel may be between 2-21 millimetres. The diameter is preferably larger than 6 millimetres. In some examples, the inner diameter of the first channel is any of 3, 6, 10, 14 and 20.4 millimetres.

As well as reducing backpressure, lower hold-up volumes in the valve block also provide for a reduced bioburden therein (e.g. of trapped biological contaminants). Improved substantially smooth fluid flow (e.g. over an increased pressure operating range) can also be designed into a solution management system etc. incorporating such a valve block (e.g. provided between inlet tubing/channel(s) and solution outlet tubing/channel(s)), which solution management system etc. may itself further contain a plurality of components fluidly connected by respective bend sections/tubes/channels/pipes.

According to an example of the present disclosure, each valve section comprises a recess with a sealing surface configured to receive and abut a valve element in the shape of a membrane or diaphragm. The valve sections in the valve block may thus form part of a diaphragm valve. The valve sections of the valve block may further comprise two or more ports connected to channels within the valve block, and a seat between the ports. When the membrane or diaphragm is pressed against the seat, the valve is closed. The movement of the membrane or diaphragm, to open or close the valve, may be controlled by means of an actuator. The actuator may be mechanical, pneumatic, hydraulic or electric. Alternatively, the actuator may be manually driven.

According to an example of the present disclosure, the valve block has six sides and further comprises at least one integrally formed hose connector portion protruding from the valve block in connection with the at least one inlet port or the at least one outlet port; wherein the at least one hose connector portion extends longitudinally with an angle in relation to the side of the valve block on which it is arranged, wherein the angle is within the range of 30-85 degrees. The hose connector portion is thus tilted or inclined with regard to the side of the valve block on which it is arranged. The hose connector portion is configured to be connected to a hose, which in turn is connected to a fluid source for delivery of fluid to the system or a fluid receiver for receiving fluid from the system. The hose connector portion is an integral part of the valve block. The hose connector portion is coaxially arranged with regard to the at least one inlet port or the at least one outlet port. Conventional valve blocks typically comprise, or are connected to, hose connectors that extend perpendicularly to a vertically arranged side of the valve block. This may cause problems with the hose being kinked, which will obstruct the flow. The force applied on the hose connector by the weight of the hose may also damage the hose connector. By means of the tilted hose connector portion, the load on the hose connector portion and the risk of kinking the hose is reduced. The hose connector portion according to the present disclosure will also allow for a more space-efficient arrangement of the connected hose since it will extend closer to the valve block. This will also reduce the risk of an operator stepping on the hose and thereby apply an external load on the hose connector portion, which ultimately could damage the hose connector portion. More details regarding the hose connector portion will be described below with regarding to a second aspect of the present disclosure.

According to the first aspect of the present disclosure, a solution management system for bioprocessing is also provided. The system comprises a valve block as disclosed above. It is to be understood that all effects and advantages relating to the valve block according to the first aspect, are also applicable on the solution management system of the first aspect.

In one example, the system further comprises an actuator package with at least one actuator and a valve element connected to the at least one actuator. In one example, the system further comprises an actuator package with at least four actuators and a valve element connected to each actuator, wherein the valve block is connected to the actuator package, such that the valve elements are aligned with and seals the valve sections of the valve block, between the valve block and the actuators. As discussed above, the valve elements may be membranes or diaphragms and are arranged between the respective actuator and the valve block. The actuators are configured to move a centre portion of the respective valve element towards or away from the valve sections of the valve block in order to close or open the valves. Each valve may be closed by pressing the centre portion of the valve element against the valve section of the valve block, such that it abuts the seat of the valve section. This way, no fluid will be able to pass between the two ports of the valve section. Each valve may be opened by releasing the pressure/force on the valve element, such that the valve element does not abut the seat of the valve section in the valve block. The system may be configured such that all valves are closed by default. It is to be understood that the system could comprise a plurality of valve blocks and corresponding actuator packages.

The actuator package may further comprise at least one actuator clamp holding at least one actuator, the actuator package being mounted in the system by the at least one actuator clamp being connected to a support structure of the system. The actuator claim may be configured to clamp at least two actuators together, whereby the at least two actuators are mounted in the system by the at least one actuator clamp being connected to a support structure of the system. The system typically comprises support structures such as frames, beams, struts or similar for various components to be connected to. The actuator clamp will facilitate handling several actuators at the same time and thus enable several actuators to be mounted in the system in a simple way. The support structure may comprise at least one recess, slot or aperture configured to receive a corresponding protrusion on the actuator clamp to thereby connect the actuator package in the system. In one example, the support structure comprises an upper strut and a lower strut, wherein the actuator clamp is arranged in between these struts and engages with both struts. The actuator clamp and thus the actuator package may be connected to the support structure such that it allows lateral movement of the actuator package. This will facilitate mounting of the actuator package and connection of the valve block since it increases the tolerances.

The valve block may be attached to the actuators by means of fasteners. The fasteners are suitably bolts or screws. When assembling the system, the actuators of each actuator package are first clamped together by means of at least one actuator clamp. The actuator package is then mounted by connecting the actuator clamp to the support structure of the system. Subsequently, the valve block is aligned with the actuator package and is connected to the actuators by means of fasteners. The valve block is arranged with at least one side facing outwards, away from the system, and is thus easily accessible from outside the system. This way of connecting the different components and mounting them in the system will also improve and facilitate handling during maintenance compared to conventional solutions. In a solution management system for bioprocessing, the valve elements are typically exchanged once a year or they may be subject to excessive wear and therefore need to be replaced. With the system as disclosed herein, the valve elements are accessed by disconnecting (unscrewing) and removing the whole valve block from the corresponding actuators. The valve block can be removed without affecting the stability of the actuator package since the actuator package is connected to the support structure via the actuator clamp. The valve block being molded or printed may also be relatively lightweight and thereby be easy to remove from the system. In conventional systems, valve elements are accessed by removing the actuators. This is more cumbersome since the actuators typically are arranged inside the valve block and are thus not as accessible as the valve block. Furthermore, the actuators may be quite heavy and could thereby complicate maintenance. As mentioned above, the valves may be closed as default. This means that the valve elements per default are pressed against the seat of the valve sections by the actuators. In such case, in order to remove the valve block during maintenance, the actuators first have to be controlled to release the pressure on the valve elements before unscrewing the valve block from the actuators. In the event that the valves are open as default the valve block can be unscrewed directly.

According to a second aspect of the present disclosure, a valve block for controlling a flow of fluid into, or out of, a solution management system for bioprocessing is provided. The valve block is a single unit with six sides and comprises: at least one inlet port arranged at any of the sides of the valve block; at least one outlet port arranged at any of the sides of the valve block; at least one valve section fluidly connected to the at least one inlet port and the at least one outlet port, the valve section being configured to receive a valve element for controlling fluid through the valve block; and at least one integrally formed hose connector portion protruding from the valve block in connection with the at least one inlet port or the at least one outlet port; wherein the at least one hose connector portion extends longitudinally with an angle in relation to the side of the valve block on which it is arranged, wherein the angle is within the range of 30-85 degrees. The angle between the hose connector portion and the side of the valve block on which it is arranged may be referred to as the tilting angle. A valve block having this tilted hose connector portion has been described above in relation to the first aspect of the present disclosure. However, it is to be understood that the valve block according to the present invention may comprise the tilted hose connector portion also without comprising the first channel.

The hose connector portion is configured to be connected to a hose, which in turn is connected to a fluid source for delivery of fluid to the system or a fluid receiver for receiving fluid from the system. The hose connector portion is coaxially arranged with regard to the at least one inlet port or the at least one outlet port. As mentioned above, by means of the tilted hose connector portion, the load on the hose connector portion is reduced and the risk of kinking the hose is also reduced. The hose connector portion according to the present disclosure will also allow for a more space-efficient arrangement of the connected hose since it will extend closer to the valve block. This will also reduce the risk of an operator stepping on the hose and thereby apply an external load on the hose connector portion, which ultimately could damage the hose connector portion. Also, in the event that someone is stepping on the hose connected to the tilted hose connector portion, the stress on the tilted hose connector portion would be greatly reduced compared to a straight hose connector portion. Having an integrally formed hose connector portion instead of a separate hose connector portion attached to the valve block will also reduce the number of joints or couplings, which will reduce the risk for leakage.

The tilting angle between the hose connector portion and the side on which it is arranged may be between 40-65 degrees. If the angle is too small, the hose connector portion may obstruct fasteners used to attach the valve block to the actuators. Therefore, the angle should be at least 30 degrees, preferably at least 35 degrees and more preferably at least 40 degrees. If the angle is too large, the risk for kinking the hose and breaking the hose connector portion is increased. Therefore, the angle should not be larger than 85 degrees, preferably not larger than 75 and more preferably not larger than 65 degrees.

The at least one hose connector portion may extend in direction downwards or upwards. When the valve block is arranged with the outermost side being essentially vertical, the hose connector portion may be arranged to tilt downwards or upwards. Downwards may be advantageous when the hose is connected to the valve block from below. The weight of the hose and gravity will make the hose fall towards the floor and the load on the hose connector portion will thus be in downward direction. Tilting the hose connector portion downwards will thereby reduce the risk of kinking the hose and breaking the hose connector portion. When the hose is connected to the valve block from above, the hose connector portion is suitably tilted upwards to reduce the load on the hose connector portion and reduce the risk of kinking the hose. It is to be understood that the hose connector portion may be tilted sideways, or in any direction, with an angle between 30-85 degrees.

The valve block comprises a third channel extending from the at least one inlet port or the at least one outlet port where the hose connector portion is arranged. This third channel may be inclined with an angle similar to the tilting angle of the hose connector portion. This way, the flow of fluid into or out from the valve block is improved. At least the part of the third channel closest to the inlet port or outlet port may be inclined with an angle similar to the tilting angle of the hose connector portion. When the hose connector portion is arranged at the at least one outlet port and is tilted downwards, and the third channel thus is inclined downwards, draining of the system is improved.

The inner diameter of the hose connector portion may be between 2-21 millimetres. The inner diameter is preferably larger than 6 millimetres. In some examples, the inner diameter of the hose connector portion is any of 3, 6, 10, 14 and 20.4 millimetres. With a hose connector portion having a smaller inner diameter, the hose will have a similarly small inner diameter and such hose may not be as likely to kink. For that reason, a hose connector portion with smaller inner diameter could be arranged with a larger tilting angle (less inclined). However, a hose connector portion having a smaller inner diameter will more easily break by the load applied by the connected hose or any external load. Thus, the inner diameter of the hose connector portion should be considered when determining the tilting angle of the hose connection portion. Also, the vertical position of the hose connector portion on the valve block may affect the tilting angle. For example, the valve block may comprise two hose connector portions with the same inner diameter, one arranged above the other. The load on the upper hose connector portion (furthest away from the floor) will be higher than the load on the lower hose connector portion (closest to the floor) if the connected hoses are falling downwards towards the floor. Thus, the upper hose connector portion may be arranged with a smaller tilting angle (more inclined) than the lower hose connector portion.

The valve block may thus comprise at least two hose connector portions extending longitudinally with different angles in relation to the respective side of the valve block on which it is arranged.

The at least one valve section may comprise a recess with a sealing surface configured to receive and abut a valve element in the shape of a membrane or diaphragm.

The valve block may comprise four or more valve sections fluidly connected to the at least one inlet port and the at least one outlet port, each valve section being configured to receive a valve element for control of fluid through the valve block; wherein at least two valve sections are fluidly connected by means of an integrally formed first channel, which changes direction two or more times. Features, details and advantages relating to the valve sections and the first channel as described with regard to the first aspect of the present disclosure are also valid for the second aspect of the present disclosure.

According to the second aspect of the present disclosure, a solution management system for bioprocessing is also provided. The system comprises a valve block according to the second aspect of the present disclosure.

The system according to the second aspect may further comprise an actuator package with at least one actuator; and a valve element connected to each actuator; wherein the valve block is connected to the actuator package, such that the valve element is aligned with and seals the valve section of the valve block, between the valve block and the actuator. The system may comprise a valve block with any number of valve sections and corresponding valve elements and actuators.

The system according to the second aspect may further comprise at least one actuator clamp clamping at least two actuators together, the actuator package being mounted in the system by the at least one actuator clamp being connected to a support structure of the system.

The valve block according to the second aspect may be attached to the actuators by means of fasteners.

The system according to second aspect may further comprise a hose connected to the at least one hose connector portion.

It is to be understood that all effects and advantages relating to the valve block according to the second aspect, are also applicable on the solution management system of the second aspect. Furthermore, features and details relating to the solution management system for bioprocessing comprising the valve block according to the first aspect of the present disclosure are also valid for the solution management system for bioprocessing comprising the valve block according to the second aspect of the present disclosure.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the appended claims.

### BRIEF DESCRIPTIONS OF THE DRAWINGS

The above objects, as well as additional objects, features and advantages of the present disclosure will be more fully appreciated by reference to the following illustrative and non-limiting detailed description of example embodiments of the present disclosure, when taken in conjunction with the accompanying drawings, of which:

FIGS. 1a-b schematically illustrate a valve block for controlling a flow of fluid into, or out of, a solution management system for bioprocessing according to an example of the present disclosure;

FIG. 2 schematically illustrates a valve block for controlling a flow of fluid into, or out of, a solution management system for bioprocessing according to an example of the present disclosure;

FIG. 3 schematically illustrates a detail of the valve block according to examples of the present disclosure;

FIG. 4 schematically illustrates a detail of the valve block according to examples of the present disclosure;

FIGS. 5a-b schematically illustrate a valve block for controlling a flow of fluid into, or out of, a solution management system for bioprocessing according to examples of the present disclosure;

FIG. 6 illustrates a valve block for controlling a flow of fluid into, or out of, a solution management system for bioprocessing according to an example of the present disclosure;

FIGS. 7a-b illustrate details of a solution management system for bioprocessing according to an example of the present disclosure; and

FIGS. 8a-b illustrate a solution management system for bioprocessing according to examples of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided merely to fully convey the scope of the disclosure to the skilled person.

It is to be understood that the terminology used herein is for purpose of describing particular embodiments only, and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the terms “comprising”, “including”, “containing” and similar wordings are intended to be open-ended transitional terms that do preclude the possibility of additional elements or steps.

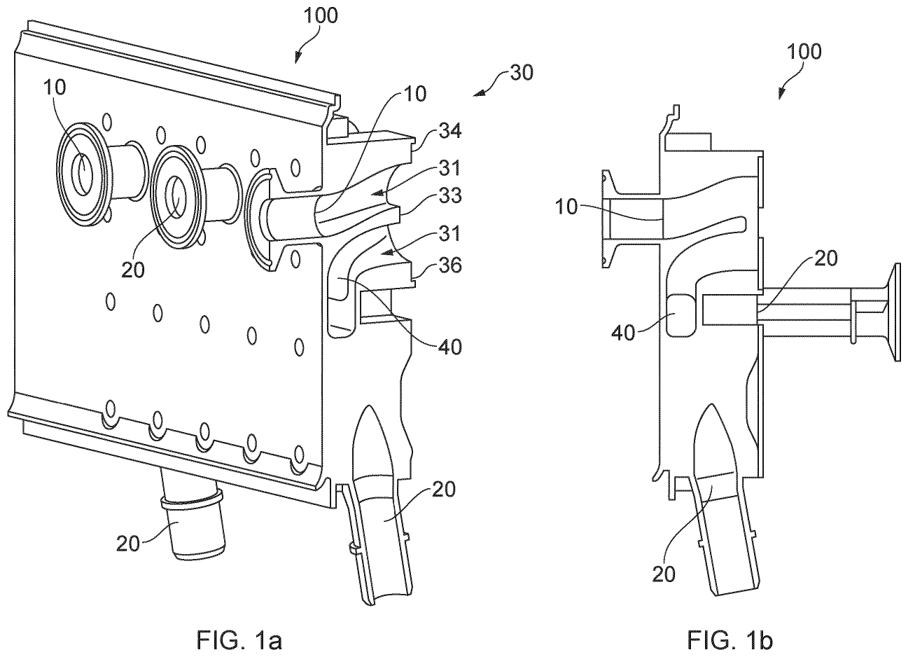

FIGS. 1a-b schematically illustrate a valve block 100 for controlling a flow of fluid into, or out of, a solution management system for bioprocessing according to an example of the present disclosure. FIG. 1a shows part of a front side of the valve block 100 and FIG. 1b is a side view of the valve block 100. The valve block 100 is a single unit and is thus made in one piece. The valve block comprises: at least one inlet port 10; at least one outlet port 20; and four or more valve sections 30 fluidly connected to the at least one inlet port 10 and the at least one outlet port 20. In this example, the valve block 100 shows two inlet ports 10 and three outlet ports 20. Only one valve section 30 is shown, but the valve block 100 in this example comprises five valve sections 30. Each valve section 30 is configured to receive a valve element (not shown) for control of fluid through the valve block 100. At least two valve sections 30 are fluidly connected by means of an integrally formed first channel 40, which changes direction two or more times.

The first channel 40 may have a substantially constant cross-sectional area. Thus, the cross-sectional area of the first channel 40 may be essentially the same along the extension of the first channel 40 even when changing direction.

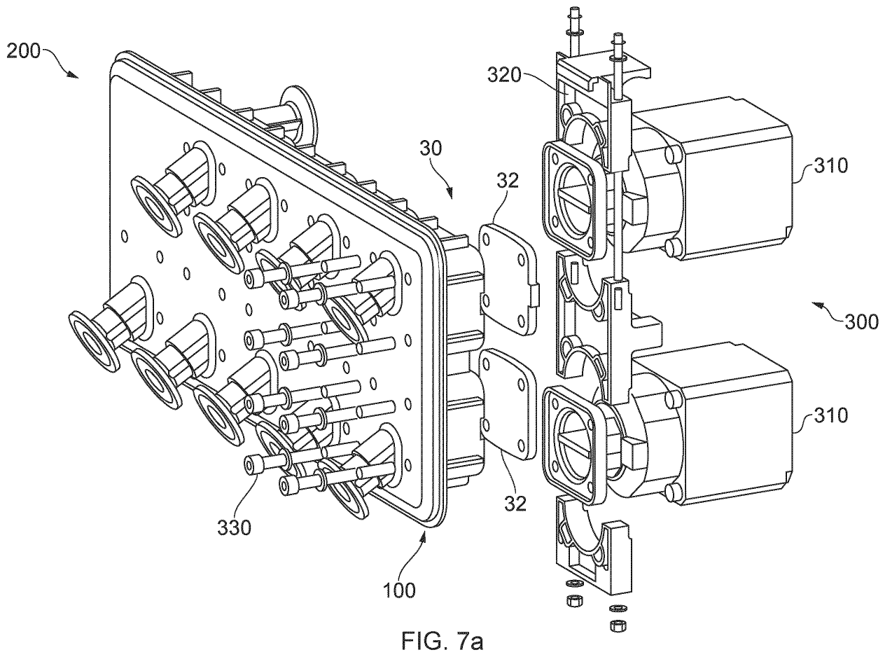

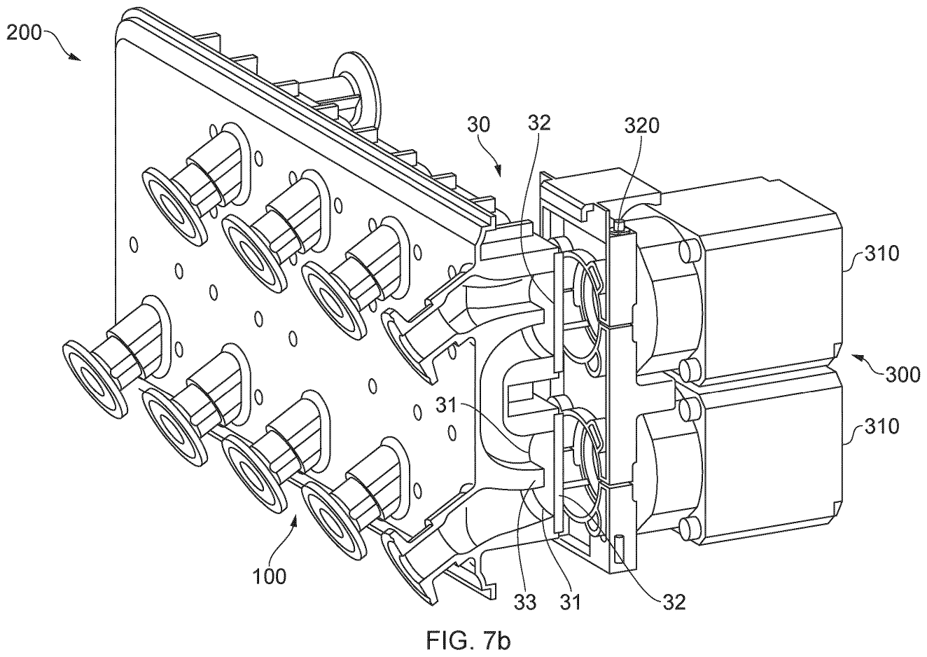

FIG. 1a shows the valve section 30 comprising a recess 34 with a sealing surface 36 configured to receive and abut a valve element (see FIG. 7a). The valve sections 30 of the valve block 100 further comprises two or more ports 31 connected to channels within the valve block 100, and a seat 33 between the ports 31.

The valve block 100 may be manufactured by means of additive manufacturing or by molding or casting.

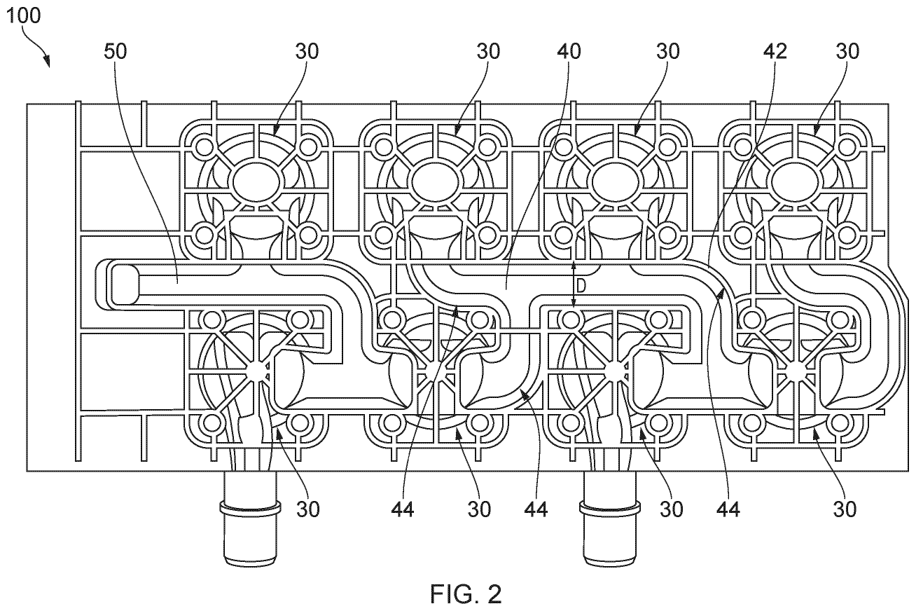

FIG. 2 schematically illustrates a valve block 100 for controlling a flow of fluid into, or out of, a solution management system for bioprocessing according to an example of the present disclosure. The valve block 100 may be configured as disclosed in FIG. 1a-b. FIG. 2 shows a cross-sectional view from the front of the valve block 100 and in this example the valve block comprises eight valve sections 30.

The first channel 40 is in this example arranged to fluidly connect two diagonally arranged valve sections 30 in the valve block 100. Additionally, the first channel 40 fluidly connects adjacent valve sections 30, such that five valve sections 30 are directly connected by means of the first channel 40.

The first channel 40 comprises at least two curved sections 44 changing the direction of the first channel 40 at least two times. In this example, the curved sections 44 are configured to provide an essentially 90-degree change of direction. The first channel 40 is delimited by channel walls 42 having a thickness between 1.6-5 millimetres. The thickness of the channel walls 42 of the first channel may vary along the extension of the first channel 40. The channel walls 42 are continuous along the longitudinal extension of the first channel 40. The inner diameter D of the first channel 40 may be between 2-21 millimetres. The inner diameter D is preferably larger than 6 millimetres. In the event that the first channel 40 has a non-circular cross-sectional shape, the first channel 40 would have a shape and/or size corresponding to an inner diameter between 2-21 millimetres.

The valve block 100 may further comprises a second channel 50. The second channel 50 may be configured similarly as the first channel 40 and may thus change direction two or more times. Alternatively, the second channel 50 is differently configured compared to the first channel 40. In one example, which is not shown in the figure, first channel 40 and the second channel 50 extend in different planes within the valve block 100 and passes each other without intersecting.

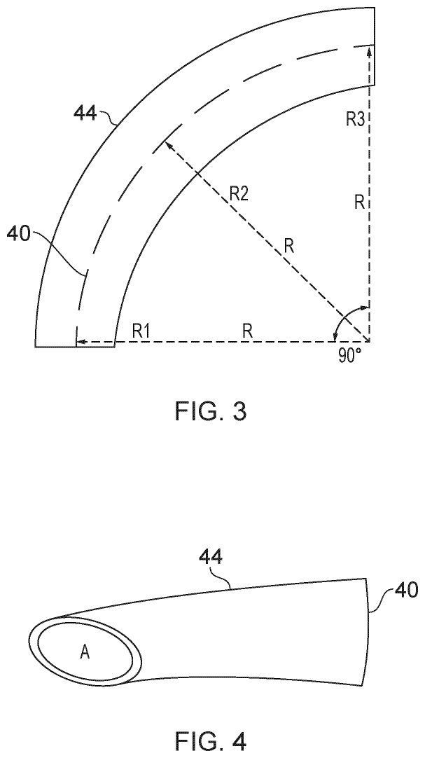

FIG. 3 schematically illustrates a detail of the valve block 100 according to examples of the present disclosure. The valve block 100 may be configured as disclosed in FIG. 1-2. In this example, at least one curved section 44 of the first channel 40 is configured, such that the radius R, of the curvature varies along at least a part of the length of the curved section 44. This is illustrated in FIG. 3 where the radius R1 at a first position of the curved section 44 is different from radius R2 at a second position along the curved section 44 and a radius R3 at a third position of the curved section 44. The radius R of the curvature of the at least one curved section 44 may vary while maintaining a constant cross-sectional area A of the first channel 40. This way, sharp bends or corners can be avoided and a continuous flow of fluid inside the channel can be achieved.

FIG. 4 schematically illustrates a detail of the valve block 100 according to examples of the present disclosure. In this example, the at least one curved section 44 of the first channel 40 has an inner cross-sectional geometry varying along at least a part of the length of the curved section 44. Thus, the first channel 40 may have a cross-sectional geometry varying along at least a part of the length of the first channel 40. The first channel 40 may have a certain cross-sectional geometry in substantially straight sections of the first channel 40, and another cross-sectional geometry in the curved sections 44. The cross-sectional geometry may vary while maintaining a constant cross-sectional area A in the curved section 44. Moreover, by providing variable cross-sectional geometry and/or variable curvature of one or more of the fluid channel(s), smoother flow, reduced pressure drop etc. can also be achieved.

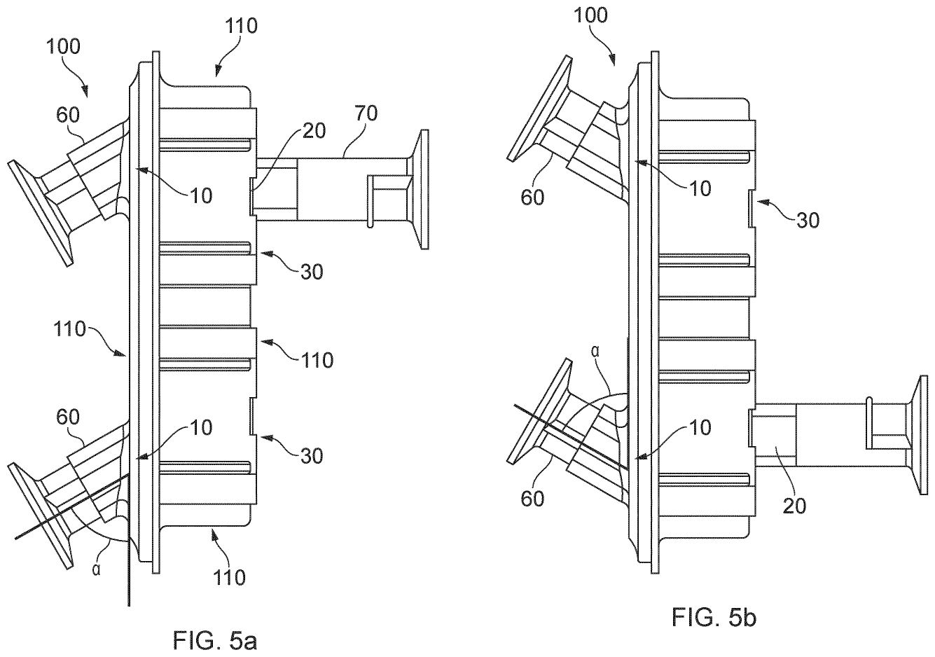

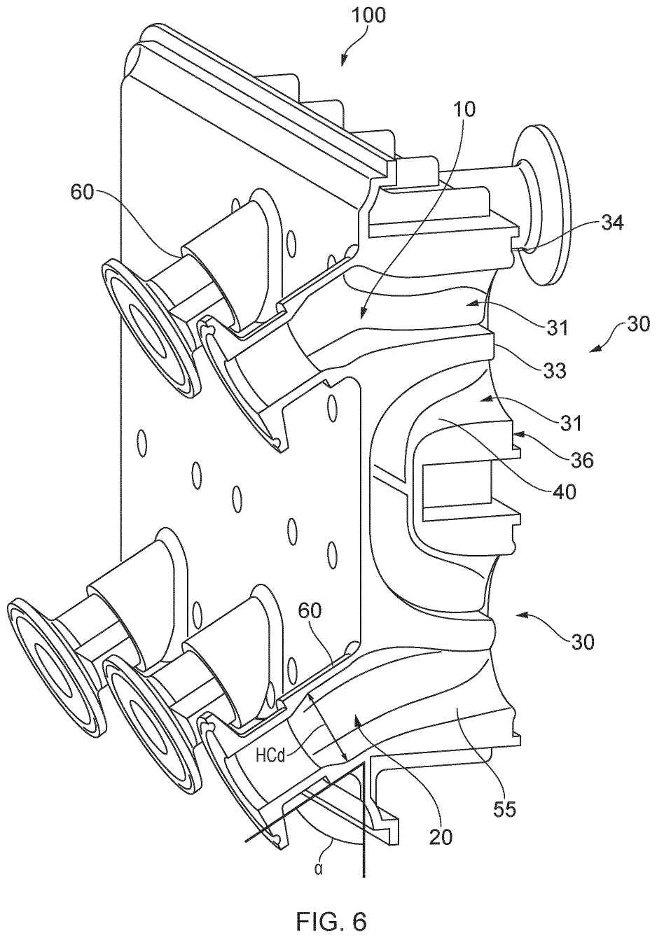

FIGS. 5a-b schematically illustrate a valve block 100 for controlling a flow of fluid into, and/or out of, a solution management system for bioprocessing according to examples of the present disclosure. The valve block 100 is a single unit with six sides 110 and comprises: at least one inlet port 10 arranged at any of the sides 110 of the valve block 100; at least one outlet port 20 arranged at any of the sides 110 of the valve block 100; and at least one valve section 30 fluidly connected to the at least one inlet port 10 and the at least one outlet port 20, the valve section 30 being configured to receive a valve element (see FIG. 7a) for controlling fluid through the valve block 100. The valve block 100 further comprises at least one integrally formed hose connector portion 60 protruding from the valve block 100 in connection with the at least one inlet port 10 or the at least one outlet port 20, wherein the at least one hose connector portion 60 extends longitudinally with an angle α in relation to the side 110 of the valve block 100 on which it is arranged, wherein the angle α is within the range of 30-85 degrees.

The angle α between the hose connector portion 60 and the side 110 of the valve block 100 on which it is arranged may be referred to as the tilting angle and a hose connector portion 60 arranged with this angle α may be referred to as a tilting hose connector portion 60. The valve block 100 may also comprise hose connector portions 70 extending essentially perpendicularly in relation to the side 110 of the valve block 100 on which it is arranged. Such hose connector portion 70 may be referred to as a straight hose connector portion 70. In the figures, two tilting hose connector portions 60 and one straight hose connector portion 70 are shown but the valve block 100 may comprise any number of hose connector portions 60, 70.

The tilting hose connector portion 60 is configured to be connected to a hose, which in turn is connected to a fluid source for delivery of fluid to the system or a fluid receiver for receiving fluid from the system. The hose connector portion 60 is coaxially arranged with regard to the at least one inlet port 10 or the at least one outlet port 20. By means of the tilting hose connector portion 60, the load on the hose connector portion 60 is reduced and the risk of kinking the hose is also reduced.

The tilting angle α between the hose connector portion 60 and the side 110 on which it is arranged may be between 40-65 degrees. If the angle α is too small, the hose connector portion 60 may obstruct fasteners used to attach the valve block 100 to the system. Therefore, the angle α should be at least 30 degrees, preferably at least 35 degrees and more preferably at least 40 degrees. If the angle α is too large, the risk for kinking the hose and breaking the hose connector portion 60 is increased. Therefore, the angle α should not be larger than 85 degrees, preferably not larger than 75 and more preferably not larger than 65 degrees.

FIG. 5a shows the tilting hose connector portions 60 extending downwards and FIG. 5b shows the hose connector portions 60 extending upwards. However, it is to be understood that the hose connector portion 60 may be tilted sideways, or in any direction, with an angle between 30-85 degrees.

FIG. 6 schematically illustrates a valve block 100 for controlling a flow of fluid into, or out of, a solution management system for bioprocessing according to an example of the present disclosure. The valve block 100 may be configured as disclosed in FIG. 5a or 5b. The valve block 100 further comprises at least two valve sections 30 that are fluidly connected by means of an integrally formed first channel 40, which changes direction two or more times. The first channel 40 may have a substantially constant cross-sectional area. Thus, the cross-sectional area of the first channel 40 may be essentially the same along the extension of the first channel 40 even when changing direction.

The valve block 100 may be manufactured by means of additive manufacturing or by molding or casting.

FIG. 6 also shows the inner diameter HCd of the hose connector portion 60, which inner diameter HCd may be between 2-21 millimetres. The inner diameter HCd is preferably larger than 6 millimetres. The inner diameter HCd may vary along the longitudinal extension of the hose connector portion 60. The valve block 100 in this example also comprises a third channel 55 extending from the at least one outlet port 20 where the hose connector portion 60 is arranged. This third channel 55 may be inclined with an angle similar to the tilting angle α of the hose connector portion 60. This way, the flow of fluid out from the valve block 100, and thus drainage, is improved. The third channel 55 may be inclined with an angle different from the tilting angle α of the hose connector portion 60. As an example, the third channel 55 may be inclined downwards, preferably less inclined than the hose connector portion 60.

The valve sections 30 each comprises a recess 34 with a sealing surface 36 configured to receive and abut a valve element (see FIG. 7a) in the shape of a membrane or diaphragm. The valve sections 30 of the valve block 100 further comprise two or more ports 31 connected to channels within the valve block 100, and a seat 33 between the ports 31.

FIGS. 7a-b illustrate details of a solution management system 200 for bioprocessing according to an example of the present disclosure. The system 200 comprises a valve block 100 as disclosed in any one of FIG. 1-6. It is to be understood that even though the valve block 100 in these figures comprises tilting hose connector portions 60, the valve block 100 may comprise straight hose connector portions 60 or no hose connector portions 60 at all.

The system 200 further comprises an actuator package 300 with at least one actuator 310 and a valve element 32 connected to the at least one actuator 310. The number of actuators 310 and valve elements 32 in each actuator package 300 may depend on the number of valve sections 30 of the valve block 100. In these figures, only two actuators 310 are shown for clarity reasons. FIG. 7a shows an exploded view of the components of the system 200 and FIG. 7b shows the same components in an assembled and connected state. The valve block 100 is connected to the actuator package 300, such that the valve elements 32 are aligned with and seals the valve sections 30 of the valve block 100. The valve elements 32 are thus arranged between the valve block 100 and the actuators 310. The valve elements 32 may be membranes or diaphragms and are arranged between the respective actuator 310 and the valve block 100. The valve elements 32 are, in the assembled state, arranged in the recess 34 of the valve section 30 and abuts the sealing surface 36. The actuators 310 are controlled to move a centre portion of the respective valve element 32 towards or away from the valve sections 30 of the valve block 100 in order to close or open the valves. To close a valve, a centre portion of the valve element 32 is pressed against the valve section 30 of the valve block 100, such that it abuts the seat 33 of the valve section 30. This way, no fluid will be able to pass between the two ports 31 of the valve section 30. To open a valve, the pressure is released, such that the valve element 32 does not abut the seat 33 of the valve section 30. The system 200 may be configured such that all valves of the valve block 100 are closed by default.

The actuator package 300 may further comprise at least one actuator clamp 320 holding at least one actuator 310. In this figure, the actuator clamp 320 is clamping at least two actuators 310 together. The actuator package 300 is mounted in the system 200 by the at least one actuator clamp 320 being connected to a support structure (not shown) of the system 200. The actuator clamp 320 will facilitate handling several actuators 310 at the same time and thus enable several actuators 310 to be mounted in the system 200 in a simple way. The actuator clamp 320 and thus the actuator package 300 may be connected to the support structure such that it allows lateral movement of the actuator package 300. This will facilitate mounting of the actuator package 300 and connection of the valve block 100 since it increases the tolerances.

When assembling the system 200, the actuators 310 of each actuator package 300 are first clamped together by means of at least one actuator clamp 320. The actuator package 300 is then mounted by connecting the actuator clamp 320 to a support structure of the system 200. Subsequently, the valve block 100 is aligned with the actuator package 300 and is connected to the actuators 310. The valve block 100 may be attached to the actuators by means of fasteners 330 as shown in FIG. 7a. The fasteners 330 are suitably bolts or screws. The valve block 100 is arranged with at least one side facing outwards, away from the system 200, and is thus easily accessible from outside the system 200. With the system 200 as disclosed in these figures, the valve elements 32 are accessed by disconnecting (unscrewing) and removing the whole valve block 100 from the corresponding actuators 310. The valve block 100 can be removed without affecting the stability of the actuator package 300 since the actuator package 300 is connected to the support structure via the actuator clamp 320. Significant time savings may thus be achieved during maintenance/servicing, especially where the system 200 contains many such easily removable valve blocks 100 (e.g. in one actual embodiment the system comprises ten such valve blocks of differing sizes). In one experimental test example, it was found by service engineers that when removing such valve blocks, rather than the actuators, service time was reduced from 45 to 15 minutes per valve block.

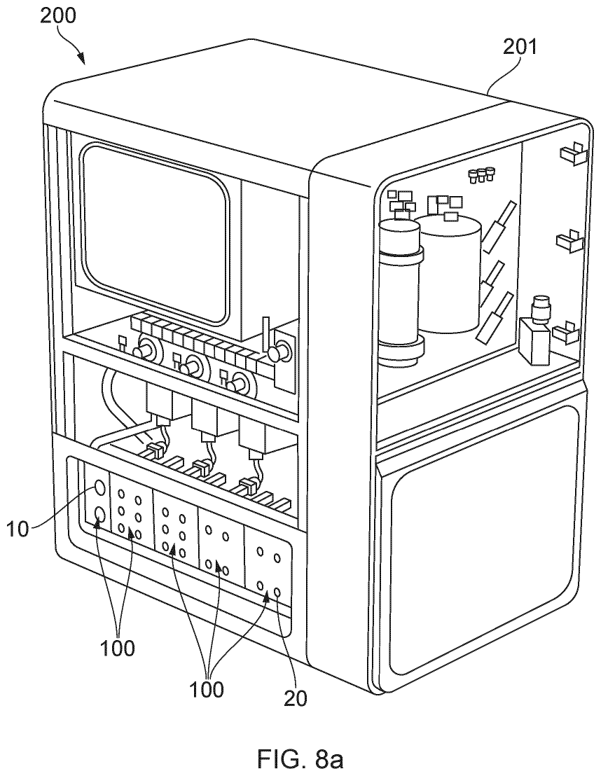

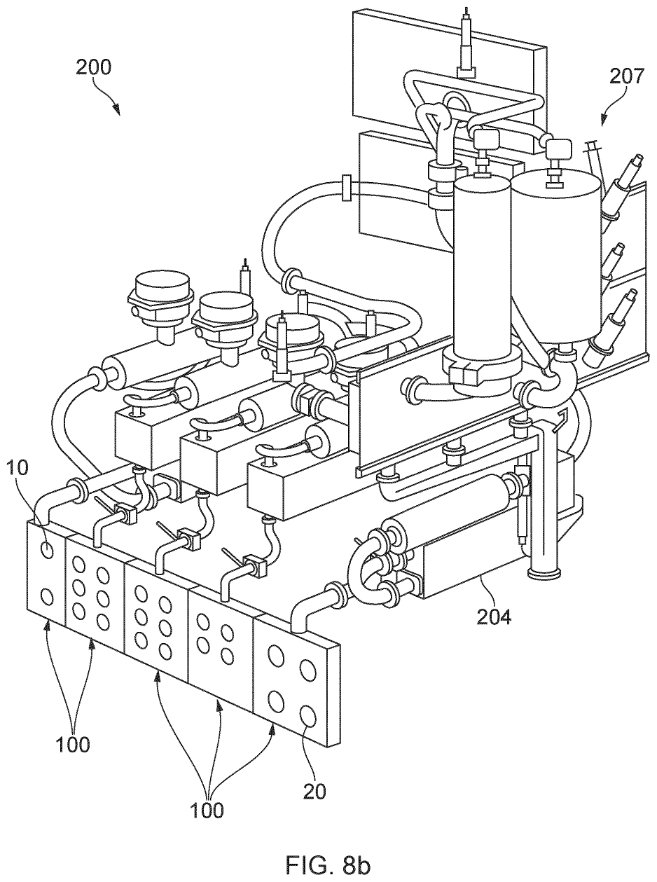

FIGS. 8a-b illustrate a solution management system 200 for bioprocessing according to examples of the present disclosure. The system 200 comprises at least one valve block 100 as disclosed in any one of FIGS. 1-6 and corresponding actuator packages 300 as disclosed in FIGS. 7a-b. In these examples, the system 200 comprises five valve blocks 100 with two, four or six inlet 10/outlet 20 ports facing outwards. It is to be understood that the inlet port 10 and the outlet port 20 shown in the figures are only examples and the inlet port 10 could be an outlet port 20 and vice versa. In FIG. 8a, the system 200 comprises an outer housing 201 enclosing the other components of the system 200.

Through the inlet ports 10 of the valve blocks 100, different solutions are entered into the system 200. The solutions may for example be different buffers, water, acid, salt, base, additive etc. The system 200 may for example comprise at least one buffer solution inlet, one water inlet, one base inlet, one acid inlet, and one additive inlet. The valves formed by the valve blocks 100 and the actuator packages 300 control the flow of solution into/out of the system 200. One or more pumps 204 are arranged to draw fluid from the inlet ports 10 through the valve blocks 100 and thereafter pump the drawn fluid out into the system 200 through pump outlet tubings/channels to generate a fluid displacement within the tubings/channels. The system 200 may comprise at least one mixer zone (not shown) for mixing solutions from the inlet ports 10. The at least one mixer zone may for example be a static mixer or a mixture junction, such as a T-, or Y-junction.

A solution characteristic unit 207 is arranged in fluid connection with the mixer zone. The solution characteristic unit 207 comprises one or more solution characteristic sensors (not shown) configured to sense one or more solution characteristic values of the mixed solution. The one or more solution characteristic sensors may for example be one or more pH sensors, one or more conductivity sensors, and/or one or more optic sensors (such as an UV sensor). The system 200 may further comprise one or more flow sensors and/or one or more pressure sensors and/or one or more temperature sensors. Based on the solution characteristics detected by the one or more solution characteristic sensors, characteristic values of the mixed solution may be registered in the solution characteristic unit 207. The solution characteristic unit 207 may comprise a processor for receiving such measured values, and for processing the values and generating (a) solution characteristic signal(s) indicative of the sensed value(s). Such a solution characteristic signal may for example be generated if the solution characteristic value(s) is/are deviating from a desired value for the certain solution being produced by the system. The solution characteristic signal may comprise information regarding the degree of deviation of the characteristic value from the desired value. A signal may or may not be raised if the characteristic value is equal to or within predetermined margins of deviation from the desired value. The solution characteristic unit/processor may be arranged to communicate with the valves connected to the inlet ports 10 for buffer/base/acid/salts/water/additive, and/or with the pumps 204 such as to increase/decrease/stop addition of e.g. base to the solution that is mixed. The processor may be arranged in/built in the system or be (wirelessly) connected to the system and arranged outside/at a distance from the system. Characteristics measured may be visualised on a monitor in (wireless) connection with the processor. The monitor may be accessible from outside of the system or be arranged outside/at a distance from the system.

The system 200 comprises at least one outlet port 20, which is fluidly connected with the solution characteristic unit. The outlet port 20 is arranged for discharging mixed solution from the solution management system 200. The outlet port 20 may connected with solution storage containers. Alternatively, the solution management system 200 can be directly connected via the outlet port 20 with for example a chromatography system (not illustrated). In yet an alternative, the solution management system 200 can be integrated in for example a chromatography system (not illustrated).

The person skilled in the art realizes that the present disclosure is not limited to the embodiments described above. For example, many types of easily releasable mechanism may be provided to enable the quick release and coupling of valve blocks 100 in a system 200. The person skilled in the art further realizes that modifications and variations are possible within the scope of the appended claims.

1. A valve block (100) for controlling a flow of fluid into, and/or out of, a solution management system for bioprocessing (200), the valve block (100) being a single unit and comprising:
at least one inlet port (10);
at least one outlet port (20); and
four or more valve sections (30) fluidly connected to the at least one inlet port (10) and the at least one outlet port (20), each valve section (30) being configured to receive a valve element (32) for control of fluid through the valve block (100);
wherein at least two valve sections (30) are fluidly connected with each other by means of an integrally formed first channel (40), which changes direction two or more times.

2. The valve block (100) according to claim 1, wherein the first channel (40) has a substantially constant cross-sectional area.

3. The valve block (100) according to claim 1, wherein the at least two fluidly connected valve sections (30) are diagonally arranged in the valve block (100).

4. The valve block (100) according to claim 1, wherein the four or more valve sections (30) are all fluidly connected with each other.

5. The valve block (100) according to claim 1, wherein the first channel (40) is delimited by channel walls (42) having a thickness between 1.6-5 mm.

6. The valve block (100) according to claim 5, wherein the channel walls (42) of the first channel (40) are continuous along the longitudinal extension of the first channel (40).

7. The valve block (100) according to claim 1, further comprising a second channel (50), wherein the first channel (40) and the second channel (50) extend in different planes within the valve block (100) and passes each other without intersecting.

8. The valve block (100) according to claim 1, wherein the first channel (40) comprises at least two curved sections (44) changing the direction of the first channel (40) at least two times, wherein at least one curved section (44) is configured, such that the radius (R) of the curvature varies along at least a part of the length of the curved section (44).

9. The valve block (100) according to claim 8, wherein at least one curved section (44) of the first channel (40) has an inner cross-sectional geometry varying along at least a portion of the length (CL) of the curved section (44).

10. The valve block (100) according to claim 1, wherein each valve section (30) comprises a recess (34) with a sealing surface (36) configured to receive and abut a valve element (32) in the shape of a membrane or diaphragm.

11. The valve block (100) according to claim 1, wherein the valve block (100) has six sides (110) and further comprises:
at least one integrally formed hose connector portion (60) protruding from the valve block (100) in connection with the at least one inlet port (10) or the at least one outlet port (20);
wherein the at least one hose connector portion (60) extends longitudinally with an angle (α) in relation to the side (110) of the valve block (100) on which it is arranged, wherein the angle (α) is within the range of 30-85 degrees.

12. A solution management system (200) for bioprocessing, the system (200) comprising at least one valve block (100) according to claim 1.

13. The system (200) according to claim 12, further comprising:
an actuator package (300) with at least four actuators (310); and
valve elements (32) connected to each actuator (310);
wherein the valve block (100) is connected to the actuator package (300), such that the valve elements (32) are aligned with and seals the valve sections (30) of the valve block (100), between the valve block (100) and the actuators (310).

14. The system (200) according to claim 13, wherein the actuator package (300) further comprises at least one actuator clamp (320) holding at least one actuator (310), the actuator package (300) being mounted in the system (200) by the at least one actuator clamp (320) being connected to a support structure (210) of the system (200).

15. The system (200) according to claim 13, wherein the valve block (100) is attached to the actuators (310) by means of fasteners (330).

16. A valve block (100) for controlling a flow of fluid into, and/or out of, a solution management system (200) for bioprocessing, the valve block (100) being a single unit with six sides (110) and comprising:
at least one inlet port (10) arranged at any of the sides (110) of the valve block (100);
at least one outlet port (20) arranged at any of the sides (110) of the valve block (100);
at least one valve section (30) fluidly connected to the at least one inlet port (10) and the at least one outlet port (20), the valve section (30) being configured to receive a valve element (32) for controlling fluid through the valve block (100); and
at least one integrally formed hose connector portion (60) protruding from the valve block (100) in connection with the at least one inlet port (10) or the at least one outlet port (20);
wherein the at least one hose connector portion (60) extends longitudinally with an angle (α) in relation to the side (110) of the valve block (100) on which it is arranged, wherein the angle (α) is within the range of 30-85 degrees.

17. The valve block (100) according to claim 16, wherein the angle (α) is within the range of 40-65 degrees.

18. The valve block (100) according to claim 16, wherein the at least one hose connector portion (60) extends in direction downwards or upwards.

19. The valve block (100) according to claim 16, wherein the valve block (100) comprises at least two hose connector portions (60) extending longitudinally with different angles (α) in relation to the respective side (110) of the valve block (100) on which it is arranged.

20. The valve block (100) according to claim 16, wherein the at least one valve section (30) comprises a recess (34) with a sealing surface (36) configured to receive and abut a valve element (32) in the shape of a membrane or diaphragm.

21. The valve block (100) according to claim 16, comprising four or more valve sections (30) fluidly connected to the at least one inlet port (10) and the at least one outlet port (30), each valve section (30) being configured to receive a valve element (32) for control of fluid through the valve block (100); wherein at least two valve sections (30) are fluidly connected by means of an integrally formed first channel (40), which changes direction two or more times.

22. A solution management system (200) for bioprocessing, the system (200) comprising at least one valve block (100) according to claim 16.

23. The system (200) according to claim 22, further comprising:
an actuator package (300) with at least one actuator (310); and
at least one valve element connected to each actuator (310);
wherein the valve block (100) is connected to the actuator package (300), such that the valve element (32) is aligned with and seals the valve section (30) of the valve block (100), between the valve block (100) and the actuator (310).

24. The system (200) according to claim 23, wherein the actuator package (300) further comprises at least one actuator clamp (320) holding at least one actuator (310), the actuator package (300) being mounted in the system (200) by the at least one actuator clamp (320) being connected to a support structure (210) of the system (200).

25. The system (200) according to claim 24, wherein the valve block (100) is attached to the actuators (310) by means of fasteners (330).
